(19) United States
(12) Patent Application Publication
(10) Pub. No.: US 2016/0236957 A1
(43) Pub. Date: Aug. 18, 2016

(54) Membrane Enhancement for Wastewater Treatment

(71) Applicant: Symphonic Water Solutions, Inc., Brookfield, WI (US)

(72) Inventor: Thomas H. Probst, Waukesha, WI (US)

(21) Appl. No.: 14/629,150

(22) Filed: Feb. 23, 2015

Related U.S. Application Data
(60) Provisional application No. 62/117,307, filed on Feb. 17, 2015.

(51) Int. Cl. C02F 9/00

(52) U.S. Cl. CPC C02F 9/00; C02F 3/308

(57) ABSTRACT

A system configured to treat a mixture having target molecules and fluid is provided. The system includes a biological reactor containing bacteria configured to remove target molecules from solution. The system includes a chemical reaction tank configured to receive a chemical additive. The system includes a membrane separation system configured to separate solid target molecules from the fluid. The system includes a second pump configured to pump the mixture from the chemical reaction tank to the membrane separation system, to pump treated permeate from the membrane separation system, and to pump retentate from the membrane separation system. The retentate from the membrane separation system is divided into a first portion and a second portion that returns to the biological reactor. The first portion of the retentate mixes the chemical additive, the feed from the biological reactor, the first portion of the retentate, and the contents of the chemical reaction tank.

### CROSS-REFERENCE TO RELATED PATENT APPLICATION

This claims priority to and the benefit of U.S. Provisional Application No. 62/117,307, filed Feb. 17, 2015, which application is incorporated herein by reference in its entirety.

### BACKGROUND OF THE INVENTION

The present invention relates generally to the field of filtration and more specifically to treatment of a fluid product containing components which may be separated or concentrated.

Many different applications require removal of a target molecule, such as target compounds, nutrients, pollutants, etc., from a fluid, such as wastewater containing contaminants to be removed therefrom. For example, membrane biological reactors are configured to reduce pollutants from wastewater, e.g., reduce organic pollutants and exclude suspended and colloidal contaminants from wastewater.

U.S. Pat. No. 7,396,453 discloses a “Hydraulically Integrated Solids/Liquid Separation System for Wastewater Treatment.”

### SUMMARY OF THE INVENTION

One embodiment of the invention relates to a mixture treatment system configured to treat a mixture having target molecules and a fluid. The system includes a biological reactor containing bacteria, the biological reactor being configured to receive the mixture, the bacteria being configured to remove target molecules from solution. The system includes a chemical reaction tank. The system includes a first pump. The first pump is configured to pump the mixture from the biological reactor to a chemical reaction tank. The chemical reaction tank is configured to receive a chemical additive. The system includes a membrane separation system. The membrane separation system is configured to separate solid target molecules from the fluid. The system includes a second pump. The second pump is configured to pump the mixture from the chemical reaction tank to the membrane separation system, to pump treated permeate from the membrane separation system, and to pump retentate from the membrane separation system. The retentate from the membrane separation system is divided into a first portion that returns to the chemical reaction tank and a second portion that returns to the bio reactor. The system is configured to add a chemical additive to the chemical reaction tank. The first portion of the retentate mixes the chemical additive, the mixture pumped from the biological reactor to the chemical reaction tank, the first portion of the retentate, and the contents of the chemical reaction tank.

Another embodiment of the invention relates to a method of removing contaminants from a fluid. The method includes providing the wastewater including contaminants to a biological reactor including bacteria. The method includes introducing a first chemical additive to the biological reactor. The method includes pumping the wastewater from the biological reactor into a chemical reaction tank. The method includes adding a second chemical additive to the chemical reaction tank. The method includes pumping the wastewater from the chemical reaction tank to a membrane separation system with the membrane separation system outputting a permeate and a retentate. A first portion of the retentate is provided to the biological reactor. A second portion of the retentate is provided to the chemical reaction tank. The second portion mixes the contents of the chemical reaction tank.

Another embodiment of the invention relates to a mixture treatment system configured to treat a mixture having target molecules and a fluid. The system includes a biological reactor containing bacteria. The biological reactor is configured to receive the mixture. The bacteria are configured to remove target molecules from solution. The system includes a chemical reaction tank. The system includes a first conduit connecting the biological reactor to the chemical reaction tank. The system includes a first pump configured to pump the mixture through the first conduit from the biological reactor to a chemical reaction tank. The chemical reaction tank is configured to receive a chemical additive. The system includes a membrane separation system. The membrane separation system is configured to separate solid target molecules from the fluid. The system includes a second conduit connecting the chemical reaction tank to the membrane separation system. The system includes a third conduit connecting the membrane separation system to the biological reactor. The system includes a fourth conduit connecting the membrane separation system to the chemical reaction tank. The system includes a second pump configured to pump the mixture from the chemical reaction tank to the membrane separation system, to pump treated permeate from the membrane separation system, and to pump retentate from the membrane separation system. The retentate from the membrane separation system is divided into a first portion that returns to the chemical reaction tank through the fourth conduit and a second portion that returns to the biological reactor. The system includes a chemical additive source configured to add a chemical additive to the chemical reaction tank. The first portion of the retentate mixes the chemical additive, the mixture pumped from the biological reactor to the chemical reaction tank, the first portion of the retentate, and the contents of the chemical reaction tank.

### BRIEF DESCRIPTION OF THE DRAWINGS

This application will become more fully understood from the following detailed description, taken in conjunction with the accompanying figures, wherein like reference numerals refer to like elements in which:

FIG. 1 is a membrane biological reactor system including a chemical reaction tank according to an exemplary embodiment.

### DETAILED DESCRIPTION

Referring generally to the figures, embodiments of a membrane biological reactor system 100 for treatment of fluid is provided. The system 100 provides for effective use of chemical additives to reduce target molecule, such as target compounds, nutrient, etc., concentration in fluid. Membrane filters, shown in the illustrated embodiment as tubular cross flow membrane separation system 102, are effective at separating solid nutrients from fluids, however, the membrane separation system 102 may be less effective at removing target molecules that are in solution from fluid flow.

In some single stage membrane biological reactors, chemical additives are introduced prior to or directly in the biological reactor. When chemical additives are introduced into the biological reactor, wastewaters with elevated target molecule concentration are constantly being added into the biological reactor. During operation, the mixture in the biological reactor reaches an equilibrium level of target molecule concentration in the fluid that may be higher than a desired level of target molecule concentration in the fluid. However, introduction of chemical additives at a point in the system where the target molecule concentration is lower may result in a permeate, e.g., treated effluent, output from the membrane separation system with a lower target molecule concentration.

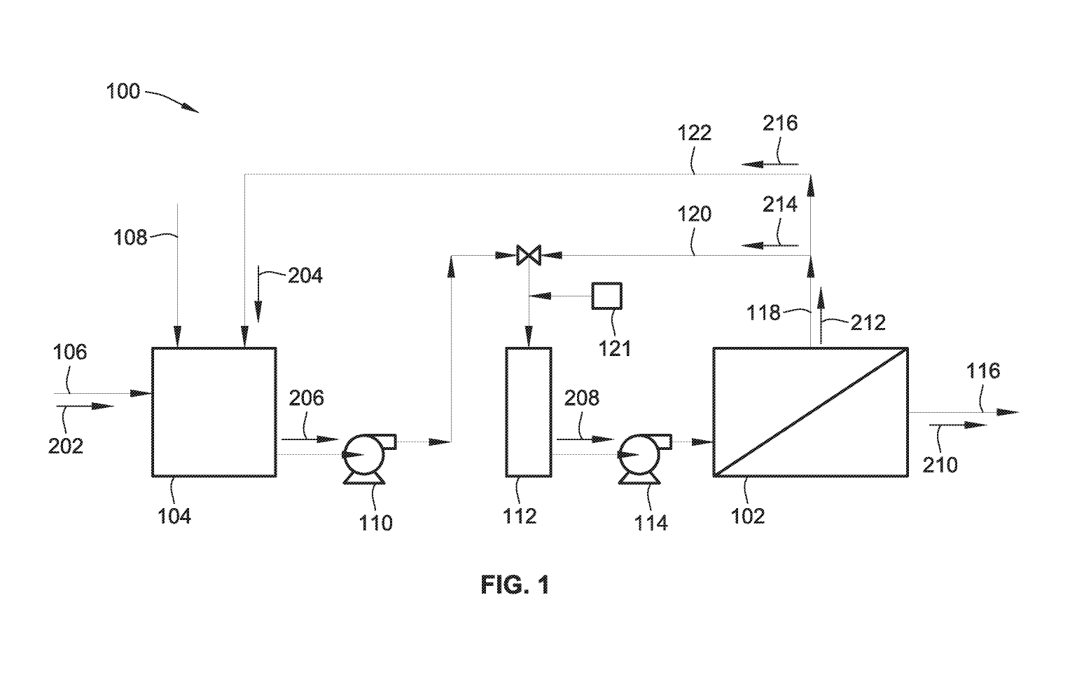

With reference to FIG. 1, an embodiment of a membrane biological reactor system 100 is illustrated. The system 100 includes a reactor, shown in FIG. 1 as a biological reactor 104. In one embodiment, the biological reactor 104 is anaerobic. In another embodiment, the biological reactor 104 is aerobic. In one embodiment, the biological reactor 104 includes bacteria configured to covert target molecules, e.g., nutrients, pollutants, etc., in solution into a suspended solid that can be separated from fluid by the membrane separation system 102. In one embodiment, the bacteria may include phosphorous accumulating organisms. In other embodiments, other suitable types of bacteria may be provided.

The biological reactor 104 is configured to receive an inflow 106 of fluid containing a target molecule, e.g., nutrient, pollutant, etc., to be removed from the fluid. In one embodiment, the inflow 106 of fluid containing target molecules is received by the reactor 104 at a rate of between 20 gallons/minute to 100 gallons/minute. In one embodiment, the inflow 106 of fluid containing nutrient is received by the reactor 104 at an average rate of approximately 50 gallons/minute. In the illustrated embodiment, the fluid is wastewater and the target molecule is phosphorus. In other embodiments, fluids containing other target molecules, nutrients, or chemically reactive components to be removed, e.g., calcium carbonate, etc., may be processed by the system 100.

In one embodiment, the wastewater inflow 106 into the biological reactor 104 has a phosphorus concentration in the range of 5 mg/L to 100 mg/L. The biological reactor 104 is also configured to receive an inflow of chemical additives 108. The chemical additives 108 are configured to react with the phosphorous in solution in the wastewater to form an insoluble precipitant with the phosphorous. In one embodiment, the chemical additives 108 include, for example, alum, e.g., hydrated potassium aluminum sulfate, double sulfate salts, ammonium iron(III) sulfate, ferric sulfate, ferric chloride, other suitable precipitant-forming chemical, etc. In another embodiment, the chemical additives 108 include sodium hydroxide, line, soda ash, etc. In other embodiments, other suitable chemical additives 108 may be used.

The mixture in the biological reactor 104 is pumped from the biological reactor 104 by a membrane system feed pump 110 into a chemical reaction tank 112. In one embodiment, the chemical reaction tank 112 has a capacity of between 10,000 gallons and 50,000 gallons. The mixture in the chemical reaction tank 112 is removed by a membrane system loop pump 114 from the chemical reaction tank 112 and pumped to the membrane separation system 102. The mixture is treated by the membrane separation system 102, e.g., a portion of fluid is forced through the membrane, with that portion of the mixture exiting the membrane separation system 102 as permeate 116, e.g., treated effluent with low concentration of phosphorous or other target compound to be rejected by the membrane, and another portion of the mixture exiting the membrane separation system 102 as retentate 118, e.g., fluid with a higher concentration of phosphorous or other target component, the now solid phosphorous or other target component not having been allowed to pass through the membrane as the permeate 116. The retentate 118 is divided into a recycled retentate portion 120 and a returned retentate portion 122. The recycled retentate portion 120 is fed back and mixed with the mixture being pumped by the membrane system feed pump 110 from the biological reactor 104 to the chemical reaction tank 112, additional chemical additives 121 from a chemical additive source are added, and the mixture is input into the chemical reaction tank 112. The returned retentate portion 122 is fed back into the biological reactor 104.

In various embodiments, membrane separation systems 102, such as tubular cross flow membrane systems, are configured to operate at high recirculating flow rates, e.g., to maintain self-cleansing velocities across the membrane surfaces, for example, in one embodiment 500 gallons/minute to 1000 gallons/minute, in another embodiment, approximately 750 gallons/minute, etc. At these operating flow rates, the chemical additives and bacteria in the biological reactor 104 are able to interact for a first amount of time in the biological reactor 104 to reduce the concentration of the phosphorous in solution in the wastewater to a first equilibrium level in the biological reactor 104. The system 100 allows for additional reaction time in other portions of the system, e.g., the chemical reaction tank 112, to further reduce the concentration of soluble phosphorous (or in other embodiments other nutrients or other target molecules or compounds) in solution in the wastewater.

In one embodiment, the system 100 includes a first conduit connecting the biological reactor to the chemical reaction tank, a second conduit connecting the chemical reaction tank to the membrane separations system, a third conduit connecting the membrane separation system to the biological reactor, and a fourth conduit connecting the membrane separation system to the chemical reaction tank.

In one embodiment, when the system 100 is in operation, the biological reactor 104 is configured to receive an inflow 202 of wastewater. In one embodiment, the inflow 202 is at a rate of 50 gallons/minute. The biological reactor 104 also receives an inflow 204 of returned retentate 122. In one embodiment, the inflow 204 is at a rate of 100 gallons/minute. The membrane system feed pump 110 is configured to pump an outflow 206 of the mixture out of the biological reactor 104. In one embodiment, the outflow 206 is at a rate of 150 gallons/minute. The membrane system loop pump 114 is configured to pump an outflow 208 from the chemical reaction tank 112 to the membrane separation system 102. In one embodiment, the outflow 208 from the chemical reaction tank 112 and into the membrane separation system 102 is at a rate of 750 gallons/minute.

An outflow 210 of permeate, e.g. treated effluent, flows out of the membrane separation system 102. In one embodiment, the outflow 210 is at a rate of 50 gallons/minute. An outflow 212 of retentate 118, e.g., fluid not having passed through the membrane system with a higher concentration of phosphorous than the permeate 116, flows out of the membrane separation system 102. In one embodiment, the outflow 212 of retentate 118 is at a rate of 700 gallons/minute. The retentate 118 is divided into a first flow 214 of recycled retentate 120 and a second flow 216 of returned retentate 122. In one embodiment, the first flow 214 is at a rate of 600 gallons/minute into the chemical reaction tank 112. In one embodiment, the second flow 216 is at a rate of 100 gallons per minute into the biological reactor 104. The first flow 214 flows into the chemical reaction tank 112 and is configured to mix and/or agitate the mixture in the tank and/or to blend forward feed, retentate/concentrate recycle flow, and the chemical additives 121 proximate the entry to the chemical reaction tank 112, promoting reaction of the soluble phosphorous or other target compound(s) with the chemical additives.

In one embodiment, the chemical reaction tank 112 has a capacity to hold enough fluid to supply the outflow 208 at the rate being pumped by the membrane system loop pump 114 to the membrane separation system 102 for at least 15 minutes. In another embodiment, the chemical reaction tank 112 has a capacity to hold enough fluid to supply the outflow 208 at the rate being pumped by the membrane system loop pump 114 for at least 30 minutes. In another embodiment, the chemical reaction tank 112 has a capacity of between 10,000 gallons and 50,000 gallons. In another embodiment, the outflow 208 is pumped at a rate of 750 gallons/minute and the chemical reaction tank 112 has a capacity of 11,250 gallons. In another embodiment, the outflow 208 is pumped at a rate of 750 gallons/minute and the chemical reaction tank 112 has a capacity of 22,500 gallons. In one embodiment, the system 100 is configured such that the mixture in the chemical reaction tank 112 is provided with between 15 minutes and 30 minutes, e.g., on average, of reaction time with the chemical additives in the chemical reaction tank 112 before being pumped to the membrane separation system 102.

In one embodiment, the chemical reaction tank is a tall, “silo-type” tank, e.g., with a relatively small footprint, with a greater height dimension than width dimension, etc. Such a tank may provide hydraulic head, e.g., back pressure, on the membrane system, greater pressure at the membrane system loop pump 114, and/or may provide improved membrane performance at a given membrane system loop pumping energy, etc.

With further reference to FIG. 1, in one embodiment, the ratio of the first retentate flow 214 (to the chemical reaction tank 112) to the second retentate flow 216 (to the biological reactor 104) is at least 2 to 1. In another embodiment, the ratio of the first retentate flow 214 (to the chemical reaction tank 112) to the second retentate flow 216 (to the biological reactor 104) is at least 3 to 1. In another embodiment, the ratio of the first retentate flow 214 (to the chemical reaction tank 112) to the second retentate flow 216 (to the biological reactor 104) is at least 4 to 1. In another embodiment, the ratio of the first retentate flow 214 (to the chemical reaction tank 112) to the second retentate flow 216 (to the biological reactor 104) is at least 5 to 1. In another embodiment, the ratio of the first retentate flow 214 (to the chemical reaction tank 112) to the second retentate flow 216 (to the biological reactor 104) is at least 6 to 1. In another embodiment, the ratio of the first retentate flow 214 (to the chemical reaction tank 112) to the second retentate flow 216 (to the biological reactor 104) is at least 7 to 1. In another embodiment, the ratio of the first retentate flow 214 (to the chemical reaction tank 112) to the second retentate flow 216 (to the biological reactor 104) is at least 8 to 1. In another embodiment, the ratio of the first retentate flow 214 (to the chemical tank 112) to the second retentate flow 216 (to the biological reactor 104) is 8 to 1. Other ratios may be used depending upon specific system and fluid characteristics.

In one embodiment, the wastewater flowing into the biological reactor 104 has a concentration of between 30 mg/L and 60 mg/L of phosphorous. The flow 206 from the biological reactor 104 to the chemical reaction tank 112 has a concentration of between 0.5 mg/L and 1.5 mg/L of soluble phosphorous. The flow 210 from the membrane separation system 102 has a concentration of between 0.03 mg/L and 0.1 mg/L of phosphorous.

In one embodiment, the membrane separation system 102 is a micro filter, an ultra filter, a nano filter, etc. In another embodiment, the membrane separation system 102 is a hollow core or plate membrane system, available from various manufacturers, e.g., GENERAL ELECTRIC, KABODA, etc. In other embodiments, other suitable types of membrane separation systems may be used.

Systems described herein may be used in various applications, e.g., industrial wastewater treatment facilities, e.g., anaerobic or aerobic, municipal sewage treatment facilities, e.g., anaerobic or aerobic, polishing of effluents, byproducts and other liquid products where chemical reactions include precipitant or amorphous solid formation to enhance a membrane system and/or create a more desirable finished product, etc. In various embodiments, mixture treatment systems may be used in processes where the retentate is to be collected from the system. In other embodiments, mixture treatment systems may be used in processes where the permeate is to be collected from the system.

In one embodiment, systems described herein may achieve nutrient levels or other target molecule or compound concentrations in the output from the membrane separation system below a predetermined concentration without the use of hydraulic mixing, for example, in the biological reactor.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes, methods of primary and supplemental mixing, and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

1. A mixture treatment system configured to treat a mixture having target molecules and a fluid, the system comprising:
a biological reactor containing bacteria, the biological reactor being configured to receive the mixture, the bacteria being configured to remove target molecules from solution;
a chemical reaction tank;
a first pump configured to pump the mixture from the biological reactor to a chemical reaction tank, the chemical reaction tank being configured to receive a chemical additive;
a membrane separation system configured to separate solid target molecules from the fluid; and
a second pump configured to pump the mixture from the chemical reaction tank to the membrane separation system, to pump treated permeate from the membrane separation system, and to pump retentate from the membrane separation system;
wherein the retentate from the membrane separation system is divided into a first portion that returns to the chemical reaction tank and a second portion that returns to the biological reactor and wherein the system is configured to add a chemical additive to the chemical reaction tank, the first portion of the retentate mixing the chemical additive, the mixture pumped from the biological reactor to the chemical reaction tank, the first portion of the retentate, and the contents of the chemical reaction tank.

2. The system of claim 1, wherein the chemical additive is a precipitant-forming chemical.

3. The system of claim 2, wherein the precipitant-forming chemical is one of hydrated potassium aluminum sulfate, double sulfate salts, ammonium iron(III) sulfate, ferric sulfate, and ferric chloride.

4. The system of claim 1, wherein the chemical reaction tank has a capacity of between 10,000 gallons and 50,000 gallons.

5. The system of claim 1, wherein the ratio between the first portion of the retentate and the second portion of the retentate is at least 2 to 1.

6. The system of claim 1, wherein the second pump is configured to pump the contents from the chemical reaction tank to the membrane separation system at a rate of 750 gallons/minute.

7. The system of claim 6, wherein the chemical reaction tank has a capacity of at least 11,250 gallons.

8. The system of claim 6, wherein the chemical reaction tank has a capacity of at least 22,500 gallons.

9. A method of removing contaminants from wastewater, the method comprising:
providing the wastewater including contaminants to a biological reactor including bacteria;
pumping the wastewater from the biological reactor into a chemical reaction tank;
adding a chemical additive to the chemical reaction tank;
pumping the wastewater from the chemical reaction tank to a membrane separation system with the membrane separation system outputting a permeate and a retentate, a first portion of the retentate being provided to the biological reactor and a second portion of the retentate being provided to the chemical reaction tank, the second portion mixing the contents of the chemical reaction tank.

10. The method of claim 9, further comprising adding a second chemical additive to the wastewater being provided to the biological reactor.

11. The method of claim 10, wherein one of the first chemical additive and the second chemical additive are alum.

12. The method of claim 10, wherein both the first chemical additive and the second chemical additive are alum.

13. The method of claim 10, wherein the first chemical additive is a different chemical additive than the second chemical additive.

14. The method of claim 9, wherein the wastewater has a concentration of contaminants of between 5 mg/L and 100 mg/L and wherein the permeate output from the membrane separation system has a concentration of contaminants of between 0.03 mg/L and 0.1 mg/L.

15. The method of claim 10, wherein the second portion is greater than the first portion.

16. A mixture treatment system configured to treat a mixture having target molecules and a fluid, the system comprising:
a biological reactor containing bacteria, the biological reactor being configured to receive the mixture, the bacteria being configured to remove target molecules from solution;
a chemical reaction tank;
a first conduit connecting the biological reactor to the chemical reaction tank;
a first pump configured to pump the mixture through the first conduit from the biological reactor to a chemical reaction tank, the chemical reaction tank being configured to receive a chemical additive;
a membrane separation system configured to separate solid target molecules from the fluid;
a second conduit connecting the chemical reaction tank to the membrane separation system;
a third conduit connecting the membrane separation system to the biological reactor;
a fourth conduit connecting the membrane separation system to the chemical reaction tank; and
a second pump configured to pump the mixture from the chemical reaction tank to the membrane separation system, to pump treated permeate from the membrane separation system, and to pump retentate from the membrane separation system;
wherein the retentate from the membrane separation system is divided into a first portion that returns to the chemical reaction tank through the fourth conduit and a second portion that returns to the biological reactor and wherein the system includes a chemical additive source configured to add a chemical additive to the chemical reaction tank, the first portion of the retentate mixing the chemical additive, the mixture pumped from the biological reactor to the chemical reaction tank, the first portion of the retentate, and the contents of the chemical reaction tank.

17. The system of claim 16, wherein the bacteria are phosphorous accumulating organisms and wherein the chemical reaction tank has a capacity of between 10,000 gallons and 50,000 gallons.

18. The system of claim 16, wherein the first portion is greater than the second portion.

19. The system of claim 16, wherein the second pump is configured to pump at an average rate of at least 700 gallons/minute.

20. The system of claim 16, wherein the chemical reaction tank has a height and a width, and wherein the height is at least 4 times the width.
